(19) United States
(12) Patent Application Publication
(10) Pub. No.: US 2008/0142609 A1
(43) Pub. Date: Jun. 19, 2008

(54) Domestic Water Heater and Method For Heating Water For Domestic Use

(76) Inventor: Werner Lissner, Starnberg (DE)

Correspondence Address: DICKINSON WRIGHT PLLC, 1901 L. STREET NW, SUITE 800, WASHINGTON, DC, 20036, US

(21) Appl. No.: 11/816,359

(22) PCT Filed: Feb. 15, 2006
(86) PCT No.: PCT/DE2006/000274

§ 371 Date: Oct. 22, 2007

(30) Foreign Application Priority Data
Feb. 16, 2005 (DE) 102005007086.8

(51) Int. Cl. B60H 1/02

(52) U.S. Cl. 237/19

(57) ABSTRACT

The invention relates to a domestic water heating unit (10) for mobile applications, with a domestic water storage unit (12). The invention provides that the domestic water heating unit (10) has a fluid/domestic water heat exchanger (14), wherein thermal energy can be supplied to the fluid (16) via an auxiliary heating device, and the thermal energy from the fluid (16) can be transferred at least in part (20) [sic] via the heat exchanger (14).

The invention further relates to a method for heating domestic water.

The invention relates to a domestic water heating unit for mobile applications, with a domestic water storage unit. The invention further relates to a method for heating domestic water for mobile applications.

Domestic water is currently heated in motor homes using primarily electricity or gas as the energy source. For stationary operation, electricity represents a convenient, rapid and safe heating option. However, electricity is ordinarily available only at corresponding hook-up sources at specially designated parking spaces and is relatively expensive. Operating the current-fed domestic water heating system using the on-board network (usually 12-volt systems) offers an insufficient buffer over longer distances and does not appear to be very economical.

Gas is relatively widely used as an energy source for heating domestic water. Disadvantages that have been identified in association with this include the availability of gas, which is not always ensured, and the danger of fire or explosion with improper use and/or improper maintenance. Furthermore, the gas supply tanks require significant storage space and decrease potential loading capacity of the motor home.

Also known is the process of using exhaust heat from the combustion engine of the motor home to heat the domestic water. With the fuel-efficient engines in use today, however, the amount of exhaust heat generated that could be used to heat the domestic water is small. Accordingly, an additional, auxiliary heat source must be provided with which the domestic water can be heated to the desired temperature.

Additionally, a domestic water heating unit for mobile applications is known, which employs a heating device to use heated air to heat the domestic water. In this process, the heated air that is already made available to the vehicle is also used to heat the domestic water. One disadvantage of this is that using heated air exclusively to heat the domestic water involves using a medium having a relatively low specific heat capacity. This can adversely affect the efficiency or the dimensions of the domestic water heating device.

The object of the invention is to further improve upon this type of domestic water heating device such that it will ensure a heating of the domestic water in a simple and efficient manner, independently of the energy sources gas and electricity.

This object is attained with the characterizing features described in the independent claims.

Advantageous further improvements and embodiments of the invention are described in the dependent claims.

The domestic water heating unit of the invention builds upon the generic prior art in that the domestic water heating unit has a fluid/domestic water heat exchanger, wherein thermal energy can be supplied to the fluid via an auxiliary heating device, and the thermal energy of the fluid can be transferred at least partially to the domestic water via the heat exchanger. In this, already existing components such as an auxiliary heating device or a fluid that has already been used can advantageously be relied upon. By using a fluid as the heat transfer medium to heat the domestic water, especially a heat transfer medium having a high specific heat capacity can be used. Furthermore, the domestic water heating unit of the invention offers the advantage that the fluid can be brought to any temperature within a selected range by means of the auxiliary heating device, thus a potentially desired heating level can also be achieved for the domestic water. At the same time, the fluid, as a heat transfer medium, can absorb any potentially existing exhaust heat from the engine of the motor home and use it to heat the domestic water. With the proper structural configuration of the fluid/domestic water heat exchanger, the domestic water and the fluid can be channeled separately, in the interest of food safety. For example, the fluid/domestic water heat exchanger can be configured as a countercurrent heat exchanger, in order to generate an efficient heat transfer. Other configurations are also conceivable, however, such as a heat exchanger according to the continuous-flow heater principle, in which the domestic water is channeled under thermal contact with the fluid within the same, or a heat exchanger, in which the fluid, channeled within the domestic water, releases thermal energy to it.

In a preferred embodiment it is provided that the fluid forms a heat transfer medium in a closed heat transfer circuit. The heat transfer circuit can, for example, be a coolant circuit in a motor home. In this manner, the domestic water heating unit can be integrated into an already existing circuit. The closed heat transfer circuit can be heated independently of the domestic water energy requirement using the auxiliary heating device, and can be used supplementarily or exclusively to heat the domestic water via the fluid/domestic water heat exchanger. The closed configuration of the circuit enables a material separation of fluid and domestic water with simultaneous thermal contact.

Especially in one embodiment it can be provided that the heat transfer circuit has solenoid valves. With the solenoid valves, a control of the heat transfer from the fluid to the domestic water can be achieved. For example, with a high domestic water energy requirement, the flow of fluid through the fluid/domestic water heat exchanger can be increased, while other energy consumers in the heat transfer circuit also receive a lower fluid flow or, optionally, can be completely removed from the circuit. Alternatively, the fluid/domestic water heat exchanger could be completely removed from the heat transfer circuit via correspondingly switched valves, if no additional domestic water heating is desired.

In a similarly preferred embodiment of the invention, the auxiliary heating device is run on a liquid fuel. Especially if the same type of fuel is used with which the motor home is operated, this enables a simple supply of the corresponding fuel to the auxiliary heating device. For example, the fuel can be taken directly from the fuel tank of the motor home, allowing a simple supply of the auxiliary heating device, and thereby of the domestic water heating device, to be achieved in stationary operation and during driving of the motor home.

A preferred embodiment of the domestic water heating device of the invention provides that the heat exchanger is arranged inside the domestic water storage unit. This arrangement facilitates placing a relatively large surface of the heat exchanger in contact with the domestic water. For example, the domestic water is able to flow directly around areas and/or surfaces of the heat exchanger. Optionally, parts of the heat exchanger can project directly into the domestic water, thereby enabling an effective transfer of heat.

In this connection, it can advantageously be further provided that the heat exchanger forms a piping section of the heat transfer circuit. This represents a simple and efficient embodiment of a heat exchanger. The piping section can, for example, dip directly into the domestic water storage unit and heat the domestic water via the heat transfer fluid flowing through it.

Especially, it can advantageously be provided that the piping section is helical in shape. The helical embodiment expands the surface of the heat exchanger available for releasing thermal energy, thereby improving the thermal contact between the heat transfer fluid and the domestic water.

Furthermore, in a preferred further improvement on the invention it can be provided that the domestic water storage unit is insulated. This ensures a supply of hot domestic water for a longer period of time after the domestic water heating unit is switched off.

With a preferred further improvement on the invention it is provided that the domestic water storage unit has a cylindrical tank. This type of shape enables cost-effective production due to a small number of weld seams.

The invention further relates to a method for heating domestic water for mobile applications, which comprises the following steps:
Using an auxiliary heating device to heat a heat transfer fluid in a heat transfer circuit;
The heat transfer fluid flowing through a fluid/fluid heat exchanger;
Transfer of at least a portion of the thermal energy from the heat transfer fluid to the domestic water via the fluid/fluid heat exchanger.

In this manner the advantages of the invention are also realized within the framework of a process.

The invention is based upon the idea of using an auxiliary heating device that is already present in a motor home, for example an engine-independent air heating system, to heat domestic water. In this, according to the invention, a coolant/domestic water heat exchanger is integrated into the coolant circuit connected to the auxiliary heating device. The heat exchanger can be configured, for example, as a spiral or helical piping section that projects into the domestic water tank. The amount of energy released to the domestic water can be controlled, for example, via solenoid valves, which supply the heating power from the engine-independent air heating system to heat the domestic water, to heat the vehicle interior, or both.

In what follows, the invention will be described in greater detail by way of example with reference to the appended set of drawings of preferred embodiments.

The drawings show:

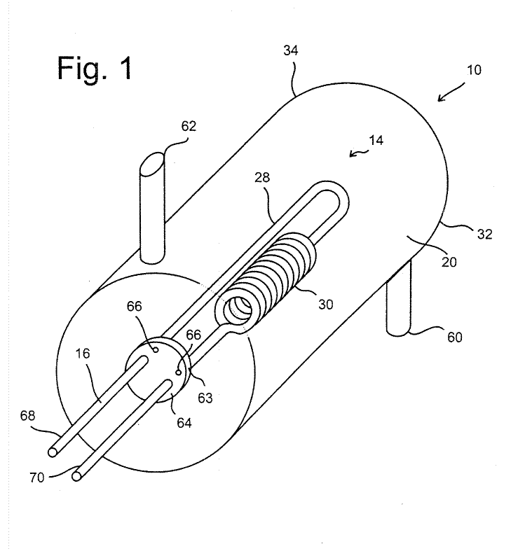

FIG. 1 a domestic water heating unit according to the invention;

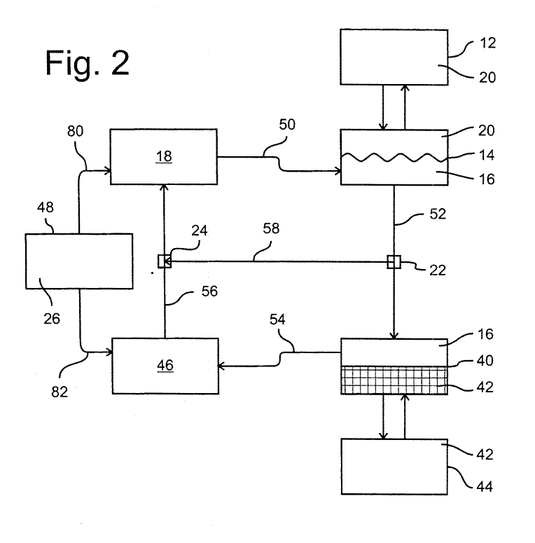

FIG. 2 a block diagram of a closed heat transfer circuit with a domestic water heating unit according to the invention;

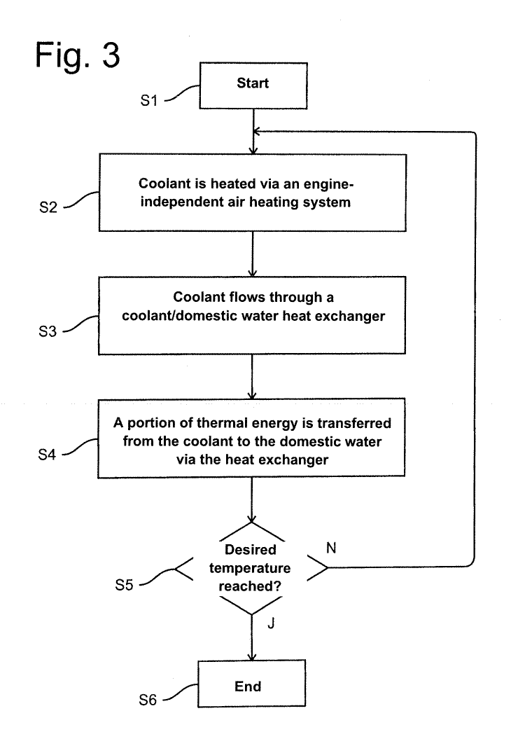

FIG. 3 a flow chart illustrating an embodiment of the method of the invention;

FIG. 1 shows a domestic water heating unit 10 according to the invention. The domestic water heating unit 10 has a domestic water tank 12. This has a circular cylindrical basic shape and in the present exemplary embodiment is arranged horizontally. On its underside, the domestic water tank 12 has a domestic water intake 60, and on its upper side it has a domestic water outlet 62. These are positioned near the opposite end surfaces of the circular cylinder and therefore lie diametrically opposite one another. Inside the domestic water tank 12 is the domestic water 20 to be heated. This is protected against a loss of thermal energy to the area around the domestic water tank 12 by a suitably thermally insulated wall 32. At the center of the end surface of the domestic water tank 12 that is adjacent to the domestic water outlet 62, a counterpart to a flange connector 63 is located, to which a flange connector 64 of the heat exchanger 14 is fastened via four flange screws 66. The heat exchanger 16 [sic] has a heat exchanger intake 68 and a heat exchanger outlet 70, which in the illustration cover two of the flange screws 66. The heat exchanger intake 68 and the heat exchanger outlet 70 are connected to the flange connector 64. The pipelines 68, 70, 28 of the heat exchanger 14 contain a coolant 16 as the heat transfer medium. On the side of the flange connector 64 that faces the domestic water tank 12 a piping section 28 of the heat exchanger 14 is connected. This extends essentially in a U shape inside the domestic water tank 12, wherein the leg allocated to the heat exchanger outlet 70 is configured as a helix 30.

The integration of the heat exchanger 14 and the domestic water tank 12 in a coolant circuit, according to the invention, is shown in FIG. 2, and is omitted in FIG. 1 for purposes of clarity.

Via the heat exchanger intake 68, the heated coolant 16 flows through the piping section 28 into the interior of the domestic water tank 12. Along the path from the heat exchanger intake 68 to the heat exchanger outlet 70, the coolant 16 flows through the helix 30. The helix 30 is completely surrounded by domestic water 20, which is thus in close thermal contact with the coolant 16 via the wall of the pipe of the helix 30. This allows the coolant to release a portion of its thermal energy to the domestic water 20. The U-shaped and/or helical arrangement of the piping section 28 inside the domestic water tank 12 permits an even heating of the domestic water 20. This results in a temperature gradient in the domestic water: Those parts of the domestic water 20 in the area of the domestic water outlet 62 have a higher temperature than those parts that are in the lower area of the domestic water tank 12 in the vicinity of the domestic water intake 60. Thus heated domestic water 20 can be drawn via the domestic water outlet 62, while at the same time cold water is supplied to the domestic water tank 12 via the domestic water intake 62 [sic].

FIG. 2 shows a block diagram of a closed heat transfer circuit with a domestic water heating unit according to the invention. The block diagram illustrates the integration of the heat exchanger 14 into a closed coolant circuit. Said circuit comprises an auxiliary heating device 18 and a vehicle engine 46 of the motor home, along with the corresponding lines. The auxiliary heating device 18 can be an auxiliary heater, which is operated when the combustion engine 46 is running, an engine-independent air heating system, which is operated when the engine 46 is not running, or a combination of auxiliary heater and engine-independent air heating system, which can be operated both when the combustion engine 46 is running and when the combustion engine 46 is not running. The auxiliary heating device 18 generates heat on the basis of combustion. In the present embodiment a fuel 26 is burned, which is also used by the combustion engine 46 to drive the motor vehicle. The fuel 26 can be diesel or gasoline, for example. The fuel 26 is located in a fuel tank 48 and is supplied via the lines 80, 82 to the auxiliary heating device 18 and/or the combustion engine 46. In addition to the combustion engine 46, the engine-independent air heating system 18 and the heat exchanger 14, the closed coolant circuit comprises a heat exchanger 40. In contrast to the fluid/domestic water heat exchanger 14, this is a fluid/air heat exchanger. In this, the thermal energy present in the coolant 16 is transferred to air 42 that is to be heated. The air 42 is used to heat the vehicle interior 44 when the vehicle is stationary or during driving, to produce comfortable interior temperatures. In addition to the listed elements, the closed coolant circuit comprises piping elements 50-58 and solenoid valves 22, 24. The solenoid valves 22, 24 are integrated into the connections between the fluid/domestic water heat exchanger 14 and the fluid/air heat exchanger 40 and between the combustion engine 46 and the engine-independent air heating system 48 [sic].

The illustrated arrangement can be operated especially in two modes: In a first operating mode the coolant 16 circulates between the elements of engine-independent air heating system 18, fluid/domestic water heat exchanger 14, fluid/air heat exchanger 40 and combustion engine 46. In this, the engine-independent air heating system 18 draws the fuel 26 from the fuel tank 48 via the pipeline 80, burns the fuel 26 and thereby heats the coolant 16. The coolant flows via the pipeline 50 to the fluid/domestic water heat exchanger 14, where it transfers a portion of its thermal energy to the domestic water 20 held in the domestic water tank 12, as described in reference to FIG. 1. Via the pipeline 52, the coolant 16 can flow to the fluid/air heat exchanger 40, and again can transfer a portion of its thermal energy to the air 42 to be heated. This is used to heat the vehicle interior 44. The coolant 16 then travels via the pipeline 54 to the combustion engine 46, where it is used to heat the combustion engine 46 to its operating temperature. Via the pipeline 56, it travels back to the engine-independent air heating system 18. In this operating mode the coolant 16 is used both to heat the domestic water 20 and the air 42 for the vehicle interior 44, and to generate the proper operating temperature for the combustion engine 46. Under certain driving conditions, however, for example if the exterior temperature is high enough, only a heating of the domestic water 20 may be desired. In this case, in a second operating mode, the solenoid valves 22, 24 can be used to decrease the size of the coolant circuit. It then comprises only the engine-independent air heating system 18 and the fluid/domestic water heat exchanger 14 and is closed via the pipeline 58. In this case, all the thermal energy of the coolant 16 can be used to heat the domestic water 20 via the fluid/domestic water heat exchanger 14.

The above-described coolant circuit is intended only to illustrate the concept of the invention. Of course, significantly more complicated circuits, for example having a greater number of solenoid valves, are also conceivable, in which, for example, each heat source and/or each individual thermal energy consumer can be added to or removed from the circuit. This type of circuit can also contain a larger or smaller number of thermal energy consumers.

FIG. 3 shows a flow chart to illustrate a process according to the invention. The process begins with Step S1. In Step S2 a coolant is heated via an engine-independent air heating system, which can also be used to heat other parts of a vehicle. In Step S3 the heated coolant flows through a coolant/domestic water heat exchanger. In Step S4 the coolant transfers at least a portion of its thermal energy to the domestic water. In Step S5 a control unit monitors whether the domestic water has achieved its desired final temperature. If so, the process ends with Step S6. Otherwise it begins again with Step S2.

The characterizing features of the invention disclosed in the above description, in the set of drawings, and in the claims can be considered essential, alone or in any combination, to implementation of the invention.

### LIST OF REFERENCE SYMBOLS

10 Domestic water heating unit
12 Domestic water storage unit
14 Fluid/domestic water heat exchanger
16 Fluid
18 Auxiliary heating device
20 Domestic water
22, 24 Solenoid valves
26 Fuel
28 Piping section
30 Helix
32 Insulation
40 Fluid/air heat exchanger
42 Air
44 Vehicle interior
46 Combustion engine
48 Fuel tank
50-58 Pipeline
60 Domestic water intake
62 Domestic water outlet
63 Flange connector counterpart
64 Flange connector
66 Flange screws
68 Heat exchanger intake
70 Heat exchanger outlet
80, 82 Fuel line

1. Domestic water heating unit for mobile applications, with a domestic water storage unit (12), characterized in that the domestic water heating unit (10) has a fluid/domestic water heat exchanger (14), wherein thermal energy can be supplied to the fluid (16) via an auxiliary heating device (18), and the thermal energy from the fluid (16) can be transferred via the heat exchanger at least partially to the domestic water (20).

2. Domestic water heating unit according to claim 1, characterized in that the fluid (16) forms a heat transfer medium for a closed heat transfer circuit.

3. Domestic water heating unit according to claim 2, characterized in that the heat transfer circuit has solenoid valves (22, 24).

4. Domestic water heating unit according to one of the preceding claims, characterized in that the auxiliary heating device (18) can be run on a liquid fuel (26).

5. Domestic water heating unit according to one of the preceding claims, characterized in that the heat exchanger is arranged inside the domestic water storage unit (12).

6. Domestic water heating unit according to claim 5, characterized in that the heat exchanger forms a piping section (28) of the heat transfer circuit.

7. Domestic water heating unit according to one of the preceding claims, characterized in that the piping section (28) is helical in shape.

8. Domestic water heating unit according to one of the preceding claims, characterized in that the domestic water storage unit (12) has insulation (32).

9. Domestic water heating unit according to one of the preceding claims, characterized in that the domestic water storage unit (12) has a cylindrical tank.

10. Method for heating domestic water for mobile applications, which comprises the following steps:
Heating a heat transfer fluid in a heat transfer circuit via an auxiliary heating system;
The heat transfer fluid flowing through a fluid/fluid heat exchanger;
Transfer of at least a portion of the thermal energy from the heat transfer fluid to the domestic water by means of the fluid/fluid heat exchanger.
